(19) United States
(12) Patent Application Publication
(10) Pub. No.: US 2025/0111666 A1
(43) Pub. Date: Apr. 3, 2025

(54) VISUALIZING MEDIA TRENDS AT A CONTENT SHARING PLATFORM

(71) Applicant: Google LLC, Mountain View, CA (US)

(72) Inventors: Mingyan Gao, Los Altos, CA (US); Hui Miao, Palo Alto, CA (US); Ye Jin, Palo Alto, CA (US); Sourabh Bansod, Mountain View, CA (US); Wenqi He, San Mateo, CA (US); Bibang Liu, Sunnyvale, CA (US); Jeffrey Daniel Forrester, Alameda, CA (US); Chao Tao, Santa Clara, CA (US); Eman Aboulatta, Santa Clara, CA (US); Jonathan Samuel Leavitt, Berkeley, CA (US)

(21) Appl. No.: 18/900,471

(22) Filed: Sep. 27, 2024

Related U.S. Application Data
(60) Provisional application No. 63/587,048, filed on Sep. 29, 2023.

(51) Int. Cl. G06V 10/94; G06F 3/0484; G06V 20/40

(52) U.S. Cl. CPC G06V 10/945; G06F 3/0484; G06V 20/40; G06V 2201/10

(57) ABSTRACT

Methods and systems for visualizing media trends at a content sharing platform are provided herein. A request of a client device is received for media items of a platform. A graphical user interface (GUI) including audiovisual content of one or more media items and an indication that the media items are associated with a media trend of the platform is provided for presentation on the client device. The media trend is associated with a set of media items, where content of the set of media items share common audiovisual characteristics in accordance with a concept of the media trend A user interaction with a GUI element associated with the media items is detected. Responsive to the detection, an additional GUI is provided for presentation on to the client device, the additional GUI including audiovisual content of a set of media items associated with the media trend.

### RELATED APPLICATIONS

This non-provisional application claims priority to U.S. Provisional Patent Application No. 63/587,048, filed Sep. 29, 2023, entitled “Visualizing Media Trends in Short-Form Video Platforms,” which is incorporated herein by reference in its entirety for all purposes.

### TECHNICAL FIELD

Aspects and implementations of the present disclosure relate to methods and systems for visualizing media trends at a content sharing platform.

### BACKGROUND

A platform (e.g., a content sharing platform, etc.) can enable to users share content with other users of the platform. For example, a user of the platform can provide a media item (e.g., a video item, etc.) to the platform to be accessible by other users of the platform. The platform can include the media item in a media item corpus of which the platform selects media items for sharing with users based on user interest. In some instances, one or more media items can be associated with a media trend. Media items associated with a media trend share a common concept or format that inspire the media item to be widely shared between users across the platform. In other instances, a media item can be associated with one or more other media characteristics. Detecting a media trend, identifying media items that are associated with the media trend, and determining other media characteristics of a media item can be time consuming and/or resource intensive for the platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving a request of a client device for media items of a platform. The method further includes providing, for presentation on the client device, a graphical user interface (GUI) including audiovisual content of one or more media items and an indication that at least one of the one or more media items is associated with a media trend of the platform. The media trend is associated with a set of media items including the one or more media items. Content of each of the set of media items share common audiovisual characteristics in accordance with a concept of the media trend. The method further includes detecting a user interaction, via the GUI, with a GUI element associated with the at least one of the one or more media items associated with the media trend. The method further includes responsive to the detection, providing, for presentation on the client device, an additional GUI including audiovisual content of the set of media items associated with the media trend.

In some implementations, the method further includes determining that one or more engagement criteria associated with the audiovisual content of a set of media items associated with the media trend included via at least one of the GUI or the additional GUI are satisfied. The method further includes updating metadata associated with the client device to indicate that the one or more engagement criteria are satisfied.

In some implementations, the method further includes receiving an additional request of the client device for additional media items of the platform. The method further includes identifying, based on the updated metadata associated with the client device, a set of additional media items for presentation via the GUI of the client device in response to the request. At least one of the set of additional media items is associated with the media trend. The method further includes updating the GUI of the client device to include audiovisual content of the set of additional media items.

In some implementations, determining that the one or more engagement criteria associated with the audiovisual content of the set of media items associated with the media trend is satisfied includes detecting an additional interaction via at least one of the GUI or the additional GUI with one or more additional GUI elements associated with designating media items associated with the media trend as media items of interest to the user.

In some implementations, the additional GUI further includes audiovisual content of one or more additional sets of media items, where each of the one or more additional sets of media items is associated with a distinct media trend of the platform.

In some implementations, the additional GUI further includes an additional GUI element that, when selected by the user, enables the user to request generation of content having at least one common audiovisual feature of the set of media items associated with the media trend.

In some implementations, the method further includes, responsive to detecting a user interaction with the additional GUI element, activating an audiovisual component of the client device. The method further includes obtaining audiovisual data generated by the activated audiovisual component. The method further includes generating an additional media item based on the obtained audiovisual data and the at least one common audiovisual feature of the set of media items.

In some implementations, the method further includes providing, for presentation on the client device, another additional GUI including one or more GUI elements corresponding to instructions for the user to replace actions to reflect audiovisual features corresponding to the media trend.

In some implementations, the additional GUI further includes an indication of a number of the set of media items associated with the media trend.

In some implementations, the additional GUI further includes an indication of a media item of the set of media items associated with the media trend for which the media trend originated.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example media item manager, and an example trend engine, in accordance with implementations of the present disclosure.

FIG. 3 is a block diagram of an example trend engine, in accordance with implementations of the present disclosure.

FIG. 4 is a block diagram of an example method for visualizing media trends at a content sharing platform, in accordance with implementations of the present disclosure.

FIGS. 5A-5C illustrate example graphical user interfaces (GUIs) for visualizing media trends at a content sharing platform, in accordance with implementations of the present disclosure.

FIGS. 6A-6B illustrate additional example GUIs for visualizing media trends at a content sharing platform, in accordance with implementations of the present disclosure.

FIG. 7 is a block diagram of an example method for enabling creator-based control of media items of a media trend, in accordance with implementations of the present disclosure.

FIG. 8 is a block diagram illustrating an exemplary computer system, in accordance with implementations of the present disclosure.

### DETAILED DESCRIPTION OF THE DRAWINGS

Aspects of the present disclosure generally relate to media item characterization based on multimodal embeddings. A platform (e.g., a content sharing platform) can enable users to share media items (e.g., video items, audio items, etc.) with other users of the platform. Some media items can include and/or share particular media item characteristics. For example, some media items can be part of or otherwise associated with a media trend. A media trend refers to a phenomenon in which a set of media items share a common format or concept and, in some instances, are distributed widely among users of a platform. Media items that are associated with a media trend may share common visual features (e.g., dance moves, poses, actions, etc.), common audio features (e.g., songs, sound bites, etc.), common metadata (e.g., hashtags, titles, etc.), and so forth. One example of a media trend can include a dance challenge trend, where associated media items depict users performing the same or a similar dance moves to a common audio signal. It can be useful for a system to identify media items that share common media item characteristics, as such identified media items can be used to determine and/or predict an overall quality and/or classification of videos included in a video corpus.

Users may provide (e.g., upload) a significantly large number of media items to the platform each day (e.g., hundreds of thousands, millions, etc.). Given such large number of uploaded media items, it can be challenging for the platform to perform media characterization tasks, such as detecting media trends among such media items and/or previously uploaded media items. For instance, on a given day, multiple users may upload media items to the platform that share a common format or concept. Users of a platform may want to be informed of new media trends that emerge at a platform and/or which media items of the platform are part of the media trend (e.g., so the users can participate in the media trend by uploading a media item sharing the common format or concept of the media trend). It can be difficult for a platform to identify, of the large number of media items uploaded by users each day, whether a new media trend has emerged and/or which media items are associated with the media trend. It can further be difficult for systems to perform other types of media characterization tasks, including but not limited to video quality prediction and/or video classification, given the large number of uploaded media items.

Some conventional systems perform media item characterization for uploaded media items based on audiovisual features of the media items and/or user-provided metadata. For instance, a conventional platform may detect that a significant number of media items uploaded within a particular time period share a common audio signal (e.g., a common song). The conventional platform may determine whether metadata (e.g., titles, captions, hashtags, etc.) provided by users associated with such media items share common features (e.g., common words in the title or caption, common hashtags, etc.) and, if so, may determine that such media items are associated with a media trend. In an illustrative example, the platform may determine that media items including the song titled “I love to dance” are each associated with the common hashtag “#lovetodancechallenge.” Therefore, the conventional platform may detect that a media trend has emerged and such media items are associated with the detected media trend. Upon detecting the media trend, the conventional platform may associate each newly uploaded media item having the common song and/or associated with the hashtag with the media trend and, in some instances, may provide a notification to users accessing such media items.

As indicated above, users can upload a significantly large number of media items to a platform each day. It can take a significant amount of computing resources (e.g., processing cycles, memory space, etc.) to identify media items sharing common audiovisual features and determine, based on the user-provided metadata, whether such media items share common media item characteristics (e.g., are associated with a new or existing media trend). In some instances, a large portion of uploaded media items can share common audiovisual features and may share some common metadata features, but in fact may not actually share common media item characteristics (e.g., may not be related to the same media trend). By basing media item characterization on common user-provided metadata, a conventional platform may not be able to accurately determine characteristics of media items uploaded to a platform, such as detecting whether a set of media items are part of the same media trend or whether the media items, although having some commonalities, are not part of the same media trend. Further, the overall characteristics of media items in a corpus can evolve multiple times during a time period (e.g., based on the characteristics of the media items being provided to the platform). Accordingly, media items of a media trend that are uploaded earlier in the time period may have different user-provided metadata than media items of the media trend that are uploaded later in the time period (e.g., due to the evolution of a media trend during the time period). Therefore, conventional platforms may be unable to accurately detect that such earlier uploaded media items and/or later uploaded media items share common media item characteristics (e.g., are part of the same media trend). In some instances, the system therefore is unable to accurately notify users of the media trend and/or which media items are part of the media trend and therefore the computing resources consumed to identify the media trend are wasted. Further, a user that wishes to participate in a media trend and/or find media items having particular characteristics may spend additional time searching through media items of the platform, which may consume further computing resources. Such computing resources are therefore unavailable to other processes of the system, which increases an overall latency and decreases an overall efficiency of the system.

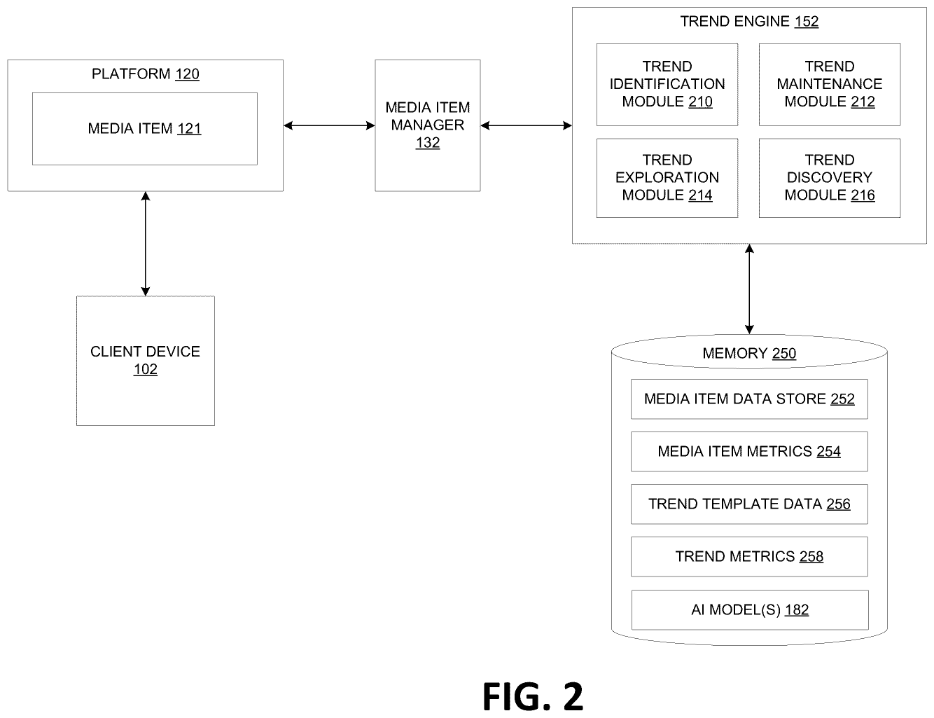

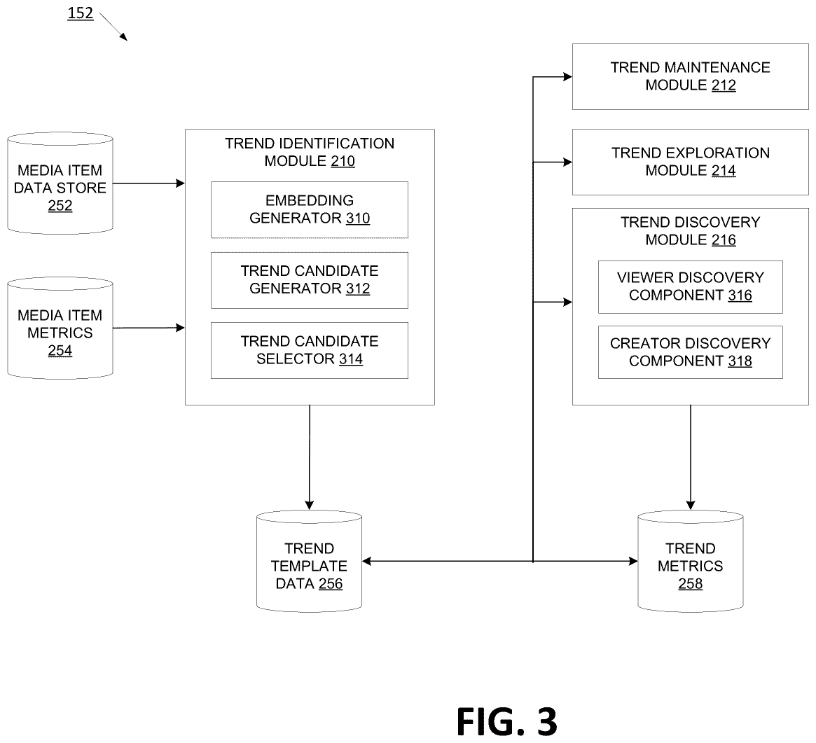

Implementations of the present disclosure address the above and other deficiencies by providing methods and systems for visualizing media trends at a content sharing platform. A system can detect one or more media trends among media items of a platform. In some embodiments, the system can detect the one or more media trends based on audiovisual embeddings and/or textual embeddings generated for the media items. For example, the system can generate a set of audiovisual embeddings and/or textual embeddings for a media item and can compare the generated set of audiovisual embeddings and/or textual embeddings to corresponding embeddings generated for one or more other media items. Upon determining that one or more coherence criteria and/or alignment criteria are satisfied based on the comparison, the system can detect that the media items are associated with a media trend, in some embodiments. In another example, the system may determine that a media item is associated with a detected media trend and may compare embeddings for the media item to embeddings generated for another media item (e.g., that is newly uploaded to the platform) to determine whether the other media item is also associated with the detected media trend. Further details regarding generating the embeddings and detecting a media trend are provided with respect to FIGS. 2 and 3 below.

In some embodiments, a user of a platform may provide a request (e.g., via a client device) for access to media items of the platform. The system may identify a set of media items for sharing with the user (e.g., based on one or more media item preferences associated with the user or the client device, based on an access history associated with the client device, etc.). In some embodiments, at least one of the identified set of media items can be associated with a detected media trend, in accordance with embodiments described herein. The system can provide the user with access to the set of media items, for example, by presenting the user with the media items (or segments of the media items) via a graphical user interface (GUI) of the client device.

In some embodiments, the system can provide a notification to the user that a particular media item of the set of media items is associated with a detected media trend. In some embodiments, the notification can indicate or otherwise identify one or more features of the media trend. For example, the notification can provide the user with an indication of a name or title of the media trend. In another example, the notification can provide the user with an indication of audio content (e.g., a song) associated with the media trend and/or a number of media items of the platform that are also associated with the media trend. In some embodiments, the system can provide the user with access to one or more GUI elements pertaining to the media trend. The one or more GUI elements may enable the user to access additional media items determined to be associated with the media trend and/or to create their own media item based on a format or concept of the media trend.

In some embodiments, the system can determine one or more visual features that are particular to the format or concept of the media trend and can provide the user with an indication of such visual features before and/or while the user creates their own media item. In an illustrative example, for a dance challenge media trend, the system can identify one or more poses that are specific to the concept of format of the dance challenge and can provide a user with one or more GUI elements depicting such poses prior to or during recording of content via a client device of the user (e.g., to enable the user to perform the dance challenge according to the one or more poses).

In additional or alternative embodiments, upon determining that a particular media item is associated with a detected media trend, the system can identify a creator associated with such media item and can provide notification of the association with the detected media trend to a client device associated with the creator. The system can, in some embodiments, provide the creator with access to one or more GUI elements (e.g., via a GUI of the client device) that enable the creator to control access to the media item, in view of the media trend. For example, a GUI element can be associated with removing the association of the media item from a set of media items associated with the detected media trend. Upon detecting a user engagement with the GUI element, the system can update metadata for the media item to indicate that the media item is no longer to be associated with the media trend (e.g., when shared with other users of the platform). In another example, a GUI element can be associated with restricting access to the media item, in view of the media trend. The creator can specify, via the GUI element, one or more categories of users of the platform that are permitted to access the media item in accordance with the media trend and/or are permitted to create additional content for the media trend inspired by the creator's media item. Further details regarding such GUI elements and creator preferences are described herein.

Aspects of the present disclosure provide techniques for enabling users to access media items associated with detected media trends and enabling creators to control access of their media items in accordance with the detected media trends. As described herein, embodiments of the present disclosure enable the system to provide a user with a notification of a particular media item that is associated with a detected media trend and, if requested by the user, provided the user with access to additional media items that are also associated with the detected media trend. Therefore, the user is able to access media items that are accurately determined to have a concept or format of a media trend without spending time and therefore computing resources trying to identify such media items (e.g., using searching techniques). Further, embodiments of the present disclosure enable the user to create their own content in accordance with the concept or format of the media trend, for example, by providing the user with a notification of the visual features of the concept or format of the media trend before or while the client device of the user records the content. Such embodiments allow for a reduction in the consumption of computing resources (e.g., memory space, processing cycles, etc.), as the user is able to create content matching (or approximately matching) the media trend more quickly, which reduces the overall number of media items generated and eventually deleted or written over by the client device of the user. Finally, embodiments of the present disclosure enable a creator to control access to their media item in accordance with the media trend, which can prevent the media item from being shared with users for which the creator has not provided permission or authorization. Such embodiments enable greater creative control of media item distribution and sharing by media item creators. Such benefits described above allow for more computing resources to be made available to other processes of a computing system, which increases the overall efficiency and decreases the overall latency of the system.

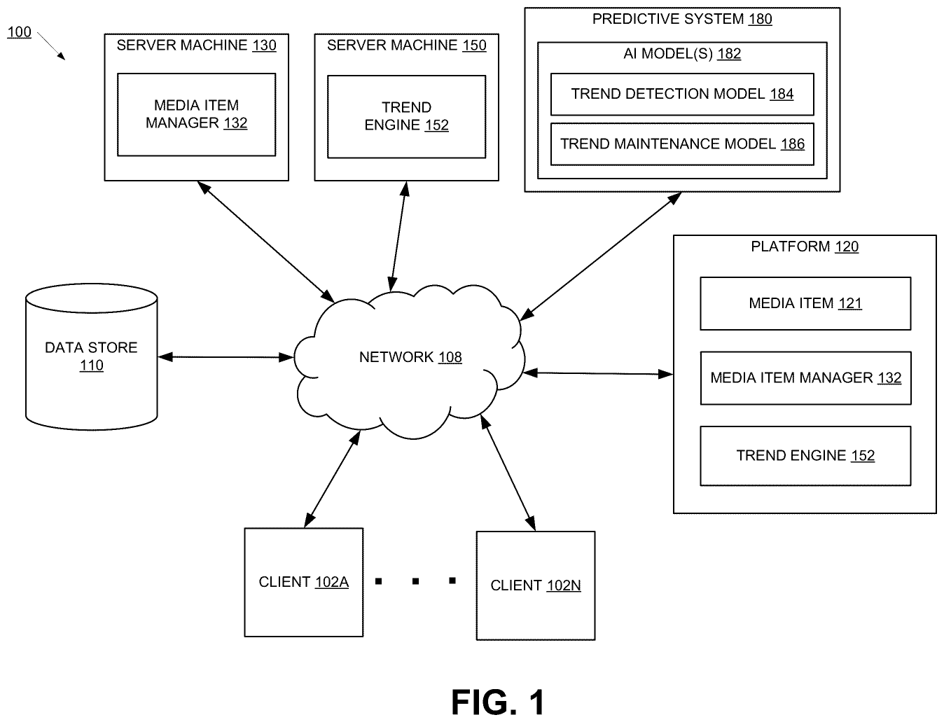

FIG. 1 illustrates an example system architecture 100, in accordance with implementations of the present disclosure. The system architecture 100 (also referred to as “system” herein) includes client devices 102A-N, a data store 110, a platform 120, and/or one or more server machines (e.g., server machine 130, server machine 150, etc.) each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N (collectively and individually referred to as client device(s) 102 herein) can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

Platform 120 can include a media item manager 132 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that creates or otherwise provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 132 can store the media item 121 at data store 110 (e.g., at a media item corpus or repository of data store 110).

In some embodiments, media item manager 132 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, one or more hashtags associated with the media item 121, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 132 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title, a caption, and/or one or more hashtags pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 132 can store the data or metadata with media item 121 at data store 110.

As used herein, a hashtag refers to a metadata tag that is prefaced by the hash symbol (e.g., “#”). A hashtag can include a word or a phrase that is used to categorize content of the media item 121. As indicated above, in some embodiments, a creator or user associated with a media item 121 can provide platform 120 with one or more hashtags for the media item 121. In other or similar embodiments, media item manager 132 and/or another component of platform 120 or of another computing device of system 100 can derive or otherwise obtain a hashtag for media item 121. It should be noted that the term “hashtag” is used throughout the description for purposes of example and illustration only. Embodiments of the present disclosure can be applied to any type of metadata tag, regardless of whether such metadata tag is prefaced by the hash symbol.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

Trend engine 152 can detect one or more media trends among media items 121 of platform 120 and/or can determine whether a respective media item 121 is associated with a media trend. A media trend refers to a phenomenon in which content of a set of media items share a common format or concept and, in some instances, are shared widely among users of platform 120. Media items that are associated with a media trend may share common visual features (e.g., dance moves, poses, actions, etc.), common audio features (e.g., songs, sound bites, etc.), common metadata (e.g., titles, captions, hashtags, etc.), and so forth. In some instances, a creator can upload to platform 120 (e.g., via a UI of a client device 102) a media item 121 including content having a particular format or concept for sharing with other users of platform 120. One or more other users of platform 120 can access the creator's media item 121 and, in some instances, may be inspired to create their own media items 121 that share the particular format or concept of the accessed media item 121. In some instances, a significantly large number of users (e.g., hundreds, thousands, millions, etc.) can create media items 121 sharing the particular format or concept of the original creator's media item 121. In accordance with embodiments described herein, trend engine 152 may detect such media items 121 sharing the particular format or concept as a media trend. Examples of media trends can include, but are not limited to, dance trends or dance challenge trends, memes or pop culture trends, branded hashtag challenge trends, and so forth. For purposes of example and illustration only, some embodiments and examples herein are described with respect to a dance trend or a dance challenge trend. It should be noted that such embodiments and examples are not intended to be limiting and embodiments of the present disclosure can be applied to any kind of media trend for any type of media item (e.g., a video item, an audio item, an image item, etc.).

As described herein, trend engine 152 may detect a media trend that originated based on a media item 121 provided by a particular creator (or group of creators). Such media item 121 is referred to herein as a “seed” media item 121. In some instances, the common format or concept shared by media items 121 of a trend may deviate from the original format or concept of the seed media item 121 that initiated the trend. In some embodiments, trend engine 152 may identify a media item 121 (or a set of media items) associated with the media trend of which the common format or concept is determined to initiate the deviation from the original format or concept of the seed media item 121. In some embodiments, such identified media item 121 may be designated as the seed media item 121 for the media trend. In other or similar embodiments, the original media item 121 and the identified media item 121 may both be designated as seed media items 121 for the media trend.

In some embodiments, trend engine 152 may determine one or more features (e.g., video features, audio features, textual features, etc.) of media items 121 of a media trend that are specific or unique to the format or concept of the media trend. Such features may define a template for the media trend for which other media items 121 replicating the media trend are to include. As described herein, trend engine 152 can determine such features and can store data indicating such features as trend template data (e.g., trend template data 256 of FIGS. 2 and 3). Trend engine 152 can determine whether subsequently uploaded media items 121 are part of a media trend by comparing features of the uploaded media items 121 to features indicated by the trend template data, in accordance with embodiments described herein. Further details regarding trend engine 152 and detecting media trends are provided herein with respect to FIGS. 2-3.

As illustrated in FIG. 1, system 100 can also include a predictive system 180, in some embodiments. Predictive system 180 can implement one or more artificial intelligence (AI) and/or machine learning (ML) techniques for performing tasks associated with media trend detection. In some embodiments, predictive system 180 can train one or more AI models 182 (e.g., a machine learning model) to detect whether a new media trend has emerged with respect to media items 121 uploaded to platform 120 and/or whether a media item 121 uploaded to platform 120 is part of a detected media trend. For purposes of explanation and example only, an AI model 182 that is trained to detect an emerging media trend is referred to as a trend detection model 184 and an AI model 182 trained to determine whether a media item 121 uploaded to platform 120 is part of a detected media trend is referred to as a trend maintenance model 186. It should be noted that while in some embodiments, functionalities of the trend detection model 184 may be separate from the functionalities of the trend maintenance model 186. However, in other or similar embodiments, functionalities of the trend detection model 184 and the trend maintenance model 186 can be performed by the same AI model 182.

It should be noted that although FIG. 1 illustrates trend engine 152 as part of platform 120, in additional or alternative embodiments, trend engine 152 can reside on one or more server machines or systems that are remote from platform 120 (e.g., server machine 130, server machine 150, predictive system 180). It should be noted that in some other implementations, the functions of server machines 130, 150, predictive system 180 and/or platform 120 can be provided by a fewer number of machines. For example, in some implementations, components and/or modules of any of server machines 130, 150 and/or predictive system 180 may be integrated into a single machine, while in other implementations components and/or modules of any of server machines 130, 150 and/or predictive system 180 may be integrated into multiple machines. In addition, in some implementations, components and/or modules of any of server machines 130, 150 and/or predictive system 180 may be integrated into platform 120.

In general, functions described in implementations as being performed by platform 120 and/or any of server machines 130, 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, an example media item manager 132, and an example trend engine 152, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 132 can identify media items 121 of interest and/or relevant to users (e.g., based on a user access history, a user search request, etc.) and can provide the users with access to the identified media items 121 via client devices 102. As described herein, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

As illustrated in FIG. 2, trend engine 152 can include a trend identification module 210, a trend maintenance module 212, a trend exploration module 214, and/or a trend discovery module 216. Trend identification module 210 can perform one or more operations associated with trend identification, which can include identification of one or more media items 121 that may initiate or otherwise correspond to an emerging media trend and/or determine trend template data for a detected media trend. Trend maintenance module 212 can perform one or more operations associated with trend maintenance, including detecting newly uploaded media items 121 that correspond to a detected media trend and, if needed, updating trend template data 256 for a detected trend based on an evolution of the media trend over time. Trend exploration module 214 can perform one or more operations associated with trend exploration, which can include determining a context and/or a purpose of the media trend and, in some embodiments, identifying features of media items 121 of the media trend of which particular audiences of users are particularly interested. Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. It should be noted that trend engine 152 can include one or more additional or alternative modules, in some embodiments. It should also be noted that although some operations or functionalities are described with respect to particular modules of trend engine 152, any of trend identification module 210, trend maintenance module 212, trend exploration module 214, trend discovery module 216, and/or any alternative or additional modules of trend engine 152 can perform any operations pertaining to trend detection and surfacing, as described herein. Details regarding trend detection by trend engine 152 are provided below with respect to FIG. 3.

In some embodiments, platform 120, media item manager 132, and/or trend engine 152, can be connected to memory 250 (e.g., via network 108, via a bus, etc.). Memory 250 can correspond to one or more regions of data store 110, in some embodiments. In other or similar embodiments, one or more portions of memory 250 can include or otherwise correspond any memory of or connected to system 100. Data, data items, data structures, and/or models stored at memory 250, as depicted by FIG. 2, are described in conjunction with FIG. 3.

FIG. 3 is a block diagram of an example trend engine 152, in accordance with implementations of the present disclosure. Trend engine 152 can include or otherwise correspond to trend engine 152 of FIGS. 1-2. As described above, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

Media items 121 evaluated by trend engine 152 can be stored at media item data store 252 of memory 250, in some embodiments. In an illustrative example, a user of a client device 102 can provide a media item 121 to platform 120 to be shared with other users of platform 120. Upon receiving the media item 121, media item manager 132 (or another component of platform 120) may store the media item 121 at media item data store 252. In some embodiments, media item data store 252 can additionally or alternatively store metadata associated with a media item 121 (e.g., a title of the media item 121, a description of the media item 121, etc.). Metadata for a media item 121 may be received by platform 120 with the media item 121 and/or may be determined by platform 120 (e.g., after receiving the media item 121). Trend engine 152 may evaluate a respective media item 121 for association with a media trend at any time after the media item 121 is received by platform 120. For example, upon receiving the media item 121, trend engine 152 may perform one or more operations described herein to determine whether the media item 121 is associated with a media trend (e.g., prior to or while users of platform 120 access media item 121). In another example, platform 120 may provide users with access to media item 121 and, after a period of time (e.g., hours, days, weeks, months, etc.), trend engine 152 may evaluate whether the media item 121 is associated with a media trend, as described herein.

As described above, trend identification module 210 can perform one or more operations associated with trend identification. Trend identification refers to the detection of media trends among media items 121 of platform 120 and/or determining whether a newly uploaded media item 121 corresponds to a previously detected media trend. In some embodiments, trend identification module 210 can include an embedding generator 310, a trend candidate generator 312, and/or a trend candidate selector 314. Embedding generator 310 can generate one or more embeddings representing features of a media item 121. An embedding refers to a representation of data (e.g., usually high-dimensional and complex) in a lower-dimensional vector space. Embeddings can transform complex data types (e.g., text, images, audio, etc.) into numerical vectors that can be processed and analyzed more efficiently by AI models or other such algorithms (e.g., AI model(s) 182). In some embodiments, embedding generator 310 can generate a set of audiovisual embeddings that represent audiovisual features of a media item 121. Embedding generator 310 can additionally or alternatively generate a set of textual embeddings that represent textual features of the media item 121. The set of audiovisual embeddings can represent one or more audiovisual features of the media item 121 and the set of textual embeddings can represent one or more textual features of the media item 121.

In some embodiments, embedding generator 310 can generate the set of audiovisual embeddings by obtaining video embeddings and audio embeddings for the media item 121 and performing one or more operations to fuse the video embeddings with the audio embeddings. The video embeddings can be obtained based on one or more outputs of an image encoder (e.g., a vision transformer, a convolutional neural network, etc.) and can represent video features of one or more frames of the media item 121, including spatial features (e.g., detected objects, people or scenery, shapes, colors, textures, etc.), temporal features (e.g., how the objects move or change over time), scene context features (e.g., an environment of a scene, background information of the video content), and so forth. The audio embeddings can be obtained based on one or more outputs of an audio encoder (e.g., an audio spectrogram transformer, etc.) and can represent audio features of the one or more frames, including pitch, timbre, rhythm, speech content (e.g., phonemes, syllables, word, etc.), speaker characteristics, environmental sounds, spectral features (e.g., frequency content), temporal dynamics (e.g., how sound evolves overtime), and so forth. Embedding generator 310 can generate the set of audiovisual embeddings by performing one or more concatenation operations with respect to the video embeddings and the audio embeddings and, in some embodiments, performing one or more attention pooling operations with respect to the concatenated video and audio embeddings. Embedding generator 310 can generate the set of textual embeddings for the media item 121 by providing textual data associated with the media item 121 (e.g., a title, a description, one or more keywords or hashtags, a transcript generated based on one or more audio signals associated with the media item 121, etc.) as an input to a text encoder (e.g., a bidirectional encoder representations from transformations (BERT) encoder, a robustly optimized BERT approach (RoBERTa) encoder, a generative pre-trained transformer (GPT) encoder, a text-to-text transfer transformer (T5) encoder, etc.).

In some embodiments, embedding generator 310 can store the embeddings generated or otherwise obtained for a media item 121 at media item data store 252 (e.g., with metadata for the media item 121). In other or similar embodiments, embedding generator 310 can store the embeddings for a media item 121 at another region of memory 250 or at another memory of or accessible to components of system 100.

Trend candidate generator 312 can identify one or more media items 121 of media item data store 252 that are candidates for association with a media trend. In some embodiments, trend candidate generator 312 can provide audiovisual embeddings and textual embeddings generated for media items 121 of media item data store 252 as an input to one or more AI models 182. The AI model(s) 182 can include a trend detection model 184, which can be trained to perform one or more clustering operations to identify clusters or groups of media items 121 sharing common or similar video and/or audio features, in view of their embeddings. In some embodiments, the one or more clustering operations can include a k-means clustering operation, a hierarchical clustering operation, gaussian mixture model (GMM) operation, or any other such type of clustering operation. Trend candidate generator 312 can obtain one or more outputs of the trend detection model 184, which can indicate a distance between each of a set of media items 121 of an identified cluster or group. The distance indicated by the model outputs can indicate a distance between of the visual or audio features for each of the set of media items 121, in view of the textual features associated with such media items 121. Trend candidate generator 312 can determine that the set of media items 121 indicated by the output(s) of the trend detection model 184 are candidates for association with a media trend by determining that the distance of the output(s) satisfies one or more distance criteria (e.g., falls below a distance threshold).

Trend candidate generator 312 can identify multiple sets of media items 121 that are candidates for different media trends, in accordance with embodiments described above. Trend candidate selector 314 can select a respective set of media items 121 identified by trend candidate generator 312 that define or are otherwise associated with a media trend of platform 120. In some embodiments, trend candidate selector 314 can select a respective set of media items 121 to be associated with a media trend by determining that the respective set of media items 121 satisfy one or more media trend criteria. The media trend criteria can be defined by a developer or operator of platform 120 and can relate to commonalties of detected media trends. In an illustrative example, a media trend criterion can be that a set of media items 121 identified as a candidate for a dance challenge media trend include a song that has characteristics associated with songs for other dance challenge media trends (e.g., high tempo, upbeat lyrics, etc.). A developer or operator of platform 120 can provide the media trend criteria to trend candidate selector 314, in some embodiments, and trend candidate selector 314 can select a respective set of media items 121 for association with a media trend by determining whether the set of media items 121 satisfies the media trend criteria. In other or similar embodiments, media trend selector 314 can provide, to a client device 102 associated with the developer or operator, an indication of one or more sets of media items identified as media trend candidates. The developer or operator can provide an indication a set of media items that satisfies the media trend criteria via a UI of the client device 102, in some embodiments.

Upon selecting or otherwise identifying a respective set of media items that are associated with a media trend, trend candidate selector 314 can determine trend template data 256 for the media trend based on data associated with each of the set of media items. Trend template data 256 can include embeddings indicating one or more common audio, video, and/or textual features of each of the set of media items that are unique to the media trend (e.g., compared to other media items 121 that are not associated with the trend). In some embodiments, trend candidate selector 314 can identify audiovisual embeddings and/or the textual embeddings representing one or more visual features, audio features, and/or textual features that are common to each of the set of media items and can store such identified embeddings as trend template data 256 for media items 121 of the media trend.

In other or similar embodiments, trend candidate selector 314 can determine a particular media item 121 of the set of media items that originated the media trend and/or best represents the media trend. Trend candidate selector 314 can identify audiovisual embeddings and/or textual embeddings representing visual features, audio features, and/or textual features for the particular media item 121 and store such identified embeddings at memory 250 as trend template data 256. Trend candidate selector 314 can determine that the particular media item 121 originated the media trend by determining that such media item 121 was provided to platform 120 before the other media item 121 of the media trend, in some embodiments. In other or similar embodiments, trend candidate selector 314 can determine that such media item 121 originated the media trend based on creation journey data associated with the media item 121 and/or other media items 121 of the media trend. In some embodiments, creation journey data can be provided by or otherwise determined for creators of media items 121 and can indicate one or more media items 121 of platform 120 that inspired the creator to upload a respective media item 121. For example, a user of platform 120 can access a first media item of another user and determine to create and provide to platform 120 a second media item with content matching or approximately matching the content of the first media item. In such example, the first media item may be determined to be part of the “creation journey” of the second media item, as content of the first media item inspired the creation of the second media item. In some embodiments, a creator may provide an indication of media items 121 that are part of the “creation journey” of a provided media item 121 via a UI of a client device 102. Such indication can be included in creation journey data associated with the media item 121 (e.g., and stored as metadata at media item data store 252). In other or similar embodiments, trend candidate selector 314 (and/or another component of trend engine 152 or platform 120) can identify media items 121 that may be included in a creation journey associated with a media item 121 provided by a creator by identifying media items 121 that the creator accessed prior to providing their media item 121. In some embodiments, trend candidate selector 314 can parse creation journey data associated with each of the set of media items identified for the media trend and can identify a particular media item 121 that satisfies one or more creation journey criteria (e.g., is included in a threshold number of creation journeys of the set of media items) as best representing the media trend.

As indicated above, trend maintenance module 212 can perform one or more operations associated with trend maintenance, including detecting newly uploaded media items 121 that correspond to a detected media trend and, if needed, updating trend template data 256 for the trend based on an evolution of the media trend over time. In some embodiments, platform 120 can receive a media item 121 from a client device of a creator for sharing with other users of the platform. Upon receiving the media item 121, embedding generator 310 may generate a set of audiovisual embeddings and/or a set of textual embeddings for the media item 121, as described herein. Trend maintenance module 212 can provide the generated embeddings for the media item 121 as an input to one or more AI models 182. In some embodiments, the one or more AI model(s) 182 can include a trend maintenance model 186, which can be trained to determine whether a media trend 121 uploaded to platform 120 is part of a detected media trend (e.g., detected by trend identification module 210). In some embodiments, trend maintenance module 212 can provide the embeddings for the media item 121 as an input to the trend maintenance model 186 and can obtain one or more outputs, which can indicate whether the media item 121 is associated with a detected media trend. Responsive to determining, based on the one or more outputs of the trend maintenance model 186, that the media item 121 is associated with a detected trend, trend maintenance module 212 can update media item data store 252 to include an indication that media item 121 is associated with the detected trend.

In some embodiments, trend maintenance module 212 may determine that one or more features (e.g., video feature, audio feature, etc.) of a user provided media item 121 may correspond to a feature of media items 121 associated with a detected media trend. In such embodiments, trend maintenance module 212 may identify the trend template data 256 associated with the detected media trend and may provide the embeddings of the identified trend template data 256 as an input to trend template model 186 (e.g., with the embeddings for the user provided media item 121. In such embodiments, trend maintenance model 186 can provide one or more outputs that indicate a distance between features of the user provided media item 121 and features indicated by the provided embeddings associated with the media trend. Trend maintenance module 212 can determine whether the user provided media item 121 is associated with the media trend by determining whether the distance indicated by the one or more outputs satisfies one or more distance criteria (e.g., falls below a distance threshold).

In some embodiments, prior to providing the embeddings for the user provided media item 121 and the embeddings associated with the media trend as an input to the trend maintenance model 186, trend maintenance module 212 can determine a degree of alignment between the embeddings of the user provided media item 121 and the embeddings associated with the media trend. For example, trend maintenance module 212 can provide the embeddings of the user provided media item 121 and the embeddings associated with the media trend as an input to an alignment function (e.g., a dynamic time warping function) and can obtain, based on one or more outputs of the alignment function, an indication of a degree of alignment between one or more visual features of the user provided media item 121 and visual features represented by the embeddings for the media trend. Trend maintenance module 212 can provide the indicated degree of alignment as an input to trend maintenance model 186, which can further inform trend maintenance model 186 of the similarities and/or distance between content of the user provided media item 121 and media items 121 of the media trend. In other or similar embodiments, trend maintenance model 186 can predict the degree of alignment between the embeddings provided as an input, and the output(s) of the trend maintenance model 186 can indicate the predicted degree of alignment.

As indicated above, trend maintenance module 212 can continuously compare features of newly uploaded media items 121 to features of media items 121 associated with detected media trends to determine whether such newly uploaded media items 121 are associated with a respective media trend. In some embodiments, trend maintenance module 212 can detect that a distance between features of media items 121 associated with a detected media trend and features of newly uploaded media items 121 determined to be associated with a media trend changes overtime. For example, trend maintenance module 212 can detect that a distance value included in the output(s) of trend maintenance module 212, while still satisfying the distance criteria, are increasing overtime. Such change can indicate to trend maintenance module 212 that the media trend may be evolving since the initial identification of the media trend. In some embodiments, trend maintenance module 212 may transmit an instruction to trend identification module 210 to perform one or more media trend identification operations with respect to the newly updated media items 121 of which the deviation from the media trend is detected. Trend identification module 210 can perform the media trend identification operations with respect to such media items 121 and can determine (e.g., based on the clustering operations performed by trend candidate generator 312) whether a new media trend is detected among such media items 121. In response to determining that the new media trend is detected, trend identification module 210 can update trend template data 256 associated with the media trend to include one or more features (e.g., visual features, audio features, textual features, etc.) for such media items 121. In some embodiments, trend maintenance module 212 can perform trend maintenance operations with respect to newly uploaded media items 121 based on the updated trend template data 256 for the media trend.

Trend exploration module 214 can perform one or more operations associated with trend exploration, which can include, in some embodiments, determining a context and/or a purpose of a detected media trend and/or identifying features of media items 121 of the detected media trend of which particular audiences of users are particularly interested. In some embodiments, trend exploration module 214 can determine the context and/or purpose of the detected media trend upon detection of the media trend. For example, trend identification module 210 can detect a new media trend among media items 121 of media item store 252, as described herein, but at the time of detection, trend engine 152 may be unaware of the context or purpose of the media trend. Trend exploration module 214 can compare features of trend template data 256 (e.g., as determined for the media trend by trend identification module 210) to features of media items 121 for other media trends for which the context or purpose is known. Upon determining that one or more features (e.g., visual features, audio features, etc.) indicated by the trend template data 256 corresponds to (e.g., matches or approximately matches) features for the media items 121 for the other media trends, trend exploration module 214 can determine that the context or purpose of the detected media trend matches the context or purpose of the other media trends. In an illustrative example, the features of the trend template data can indicate that the audio signal of media items 121 of a detected media trend includes a steady beat, a fast tempo, a high or medium degree of syncopation, and so forth. Trend exploration module 214 can compare these features to features of media items 121 associated with other media trends at platform 120 and can determine, based on the comparison, that features of the detected media trend match features of media items 121 for dance challenge trends. Therefore, trend exploration module 214 can determine that the context or purpose of the detected media trend is a dance challenge. In some embodiments, trend exploration module 214 can update trend template data 256 to include an indication of the determined context or purpose for the detected media trend.

Trend exploration module 214 can also collect trend metrics 258 for a respective media trend, which includes data indicating user engagement associated with media items 121 of a particular media trend. User engagement can include, but is not limited to, viewership engagement (e.g., a number of times the media item 121 has been watched, the amount of time users spend watching the media item 121, the percentage of users who watch the entire media item 121, etc.), interaction engagement (e.g., approval or disapproval expressions provided by users, comments provided by users, a number of times users have shared the media item 121 with other users, etc.), social engagement (e.g., mentions or tags associated with the media item 121 in social media posts or comments, etc.), user retention engagement (e.g., the number of users that rewatch the media item 121, etc.), interactive engagement (e.g., user engagement with polls or quizzes associated with the media item 121), feedback engagement (e.g., user responses in surveys, reviews, etc. associated with the media item 121), and so forth. In some embodiments, trend exploration module 214 can collect user engagement data for each media item 121 associated with a respective media trend 121 determined to be associated with a media trend and can aggregate the collected user engagement data for each media trend as one or more media trend metrics 258. In an illustrative example, a media trend metric 258 for a respective media trend can indicate a factor of component of user engagement across all media items 121 associated with the respective media trend. In some embodiments, trend metrics 258 can also include data or other information associated with the characteristics of users and/or client devices that are accessing and/or engaging with media items 121 of the media trend and/or are not accessing and/or engaging with media items 121 of the media trend.

In some embodiments, trend exploration module 214 can detect when a previously detected media trend has become inactive or unsuccessful. An inactive media trend refers to a media trend of which a degree or frequency of association with newly uploaded media items 121 within a particular time period falls below a threshold degree or a threshold frequency. An unsuccessful media trend refers to a media trend of which values of media trend metrics 258 (e.g., pertaining to user access and/or user engagement) satisfy one or more unsuccessful trend criteria. For example, trend exploration module 214 can determine that a media trend is unsuccessful upon determining that an aggregate number of users that have shared media items 121 of the media trend falls below a threshold number. In another example, trend exploration module 214 can determine that a media trend is unsuccessful upon determining that an aggregate number of disapproval expressions (e.g., “dislikes”) for media items 121 of the media trend exceeds a threshold number and/or an aggregate number of approval expressions (e.g., “likes”) for media items 121 of the media trend falls below a threshold number. Upon determining that a media trend has become inactive or unsuccessful, media item manager 132 (or another component or module of trend engine 152) can perform one or more operations to update trend template data 256 to indicate that the media trend is an inactive or an unsuccessful media trend. In some embodiments, trend engine 152 can remove trend template data 256 for the inactive or unsuccessful media trend from memory 250 based on the indication.

Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. As illustrated in FIG. 3, trend discovery module 216 can include a viewer discovery component 316 and/or a creator discovery component 318. As described herein, media item manager 132 can provide a user with access to media item 121 (e.g., upon receiving a request from a client device 102 of the user). In some embodiments, viewer discovery component 316 can detect that a media item 121 to be provided to a client device 102 is determined to be associated with a detected media trend, in accordance with previously described embodiments, and can provide a notification to the client device 102 (e.g., with the media item 121) indicating that the media item 121 is associated with the media trend. In some embodiments, viewer discover component 316 can also provide a user with an indication of one or more additional media items 121 associated with the media trend (e.g., in response to a request from the client device 102).

As described above, trend identification module 210 can identify one or more media items 121 that originated or created a media trend. In some embodiments, creator discovery component 318 can provide a notification to creators associated with the identified media item(s) 121 that their media item 121 is determined to have originated or created the media trend. For example, upon identification of the one or more media items 121, creator discovery component 318 can determine an identifier for a user and/or a client device 102 that provided the media item 121 and can transmit the notification to the client device 102 associated with the user. In some embodiments, the creator discovery component 318 can additionally or alternatively provide to the client device 102 one or more UI elements that enable the creator to control the user or distribution of their media item 121 in accordance with the media trend. For example, the one or more UI elements can enable the creator to prevent or limit notifying other users accessing the media item 121 that the media item 121 is associated with the media trend. In another example, the one or more UI elements can enable the creator to prevent or limit sharing of the media item 121 between other users of platform 120. In some embodiments, creator discovery component 318 can update media item data store 252 to indicate the preferences provided by the creator (e.g., based on user engagement with the one or more UI elements). Viewer discovery component 316 and/or media item manager 132 can provide access to the media item 121 and/or enable sharing of the media item 121 in accordance with the creator preferences, in some embodiments.

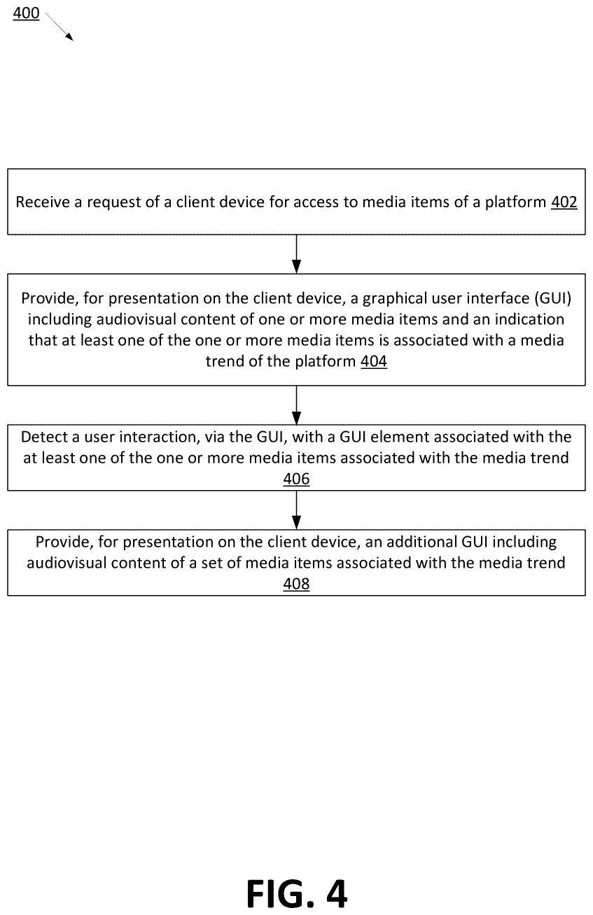

FIG. 4 is a block diagram of an example method for visualizing media trends at a content sharing platform, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by media item manager 132 and/or trend engine 152. For example, some or all of operations of method 400 can be performed by one or more components of trend discovery module 216 (e.g., viewer discovery component 316). In other or similar embodiments, some or all the operations of method 400 can be performed by a client device 102 of system 100. In yet other or similar embodiments, some or all of the operations of method 400 can be performed by media item manager 132 and/or trend engine 152, and one or more client devices 102 of system 100 (e.g., in parallel, concurrently, sequentially, etc.).

At block 402, processing logic receives a request from a client device to access media items of a platform. In some embodiments, a user of platform 120 can provide a request (e.g., via a client device 102) for access to media items 121 of platform 120. Upon receiving the request, media item manager 132 can identify one or more media items 121 for sharing with the user in accordance with the request. In some embodiments, media item manager 132 can identify the media items 121 for sharing by determining one or more content preferences associated with the user and/or the client device 102. The content preferences can be stored at memory 250 (or another memory of system 100) and can indicate a type of content, content of one or more content creators, etc. for which the user prefers to access (e.g., based on historical access history by the client device 102). Media item manager 132 can identify one or more media items 121 including content that is the same or similar to the content indicated by the content preferences for sharing with the user in accordance with the request.

In other or similar embodiments, media item manager 132 can identify media items 121 for sharing with the user based on content preferences associated with other users of platform 120 that have similar characteristics to the user. For example, media item manager 132 can determine a geographical region associated with client device 102 (e.g., based on information provided to platform 120 by the user, based on a networking address associated with client device 102, etc.). Media item manager 132 can identify media items 121 that have been accessed by users of other client devices 102 within that region and can identify such media items 121 for sharing with the user of the client device 102, in accordance with the request. It should be noted that media item manager 132 can identify media items 121 for sharing with the user according to any technique for identifying content of relevance and/or interest to a user of platform 120, in accordance with embodiments described herein.

In some embodiments, at least one of the media items 121 identified for sharing with the user may be associated with a media trend detected at platform 120. As described above, a media trend refers to a phenomenon in which a set of media items share a common format or concept and, in some instances, is shared widely among users of platform 120. In some embodiments, trend engine 152 can determine that a media item 121 is associated with a media trend in accordance with embodiments described with respect to FIGS. 2 and 3. For example, trend identification module 210 can determine that the media item 121 is associated with a media trend detected among media items 121 of platform 120 (e.g., based on one or more outputs of trend detection model 184). In another example, trend maintenance module 212 can determine that the media item 121 is associated with a media trend based on a comparison between audiovisual features of the media item 121 with audiovisual features of another media item determined to be associated with the media trend (e.g., based on one or more outputs of trend maintenance model 186). In some embodiments, processing logic can determine that a media item 121 of a set of media items identified for sharing with the user is associated with a media trend based on metadata for the media item 121 (e.g., stored at media item data store 252), as described above.

At block 404, processing logic provides, to the client device, a graphical user interface (GUI) including audiovisual content of one or more media items and an indication that at least one of the one or more media items is associated with a media trend of a platform. In some embodiments, media item manager 132 and/or another component of system 100 can provide the user with access to each of the set of media items identified for sharing with the user via the GUI at client device 102. In some embodiments, media item manager 132 can provide the user with access to each of the set of media items simultaneously. In other or similar embodiments, media item manager 132 can provide the user with access to a first media item of the set of media items. Upon detecting that the user has consumed the first media item and/or has requested access to another media item (e.g., based on a user interaction with a GUI element), media item manager 132 can provide the user with access to a second media item of the set of media items.

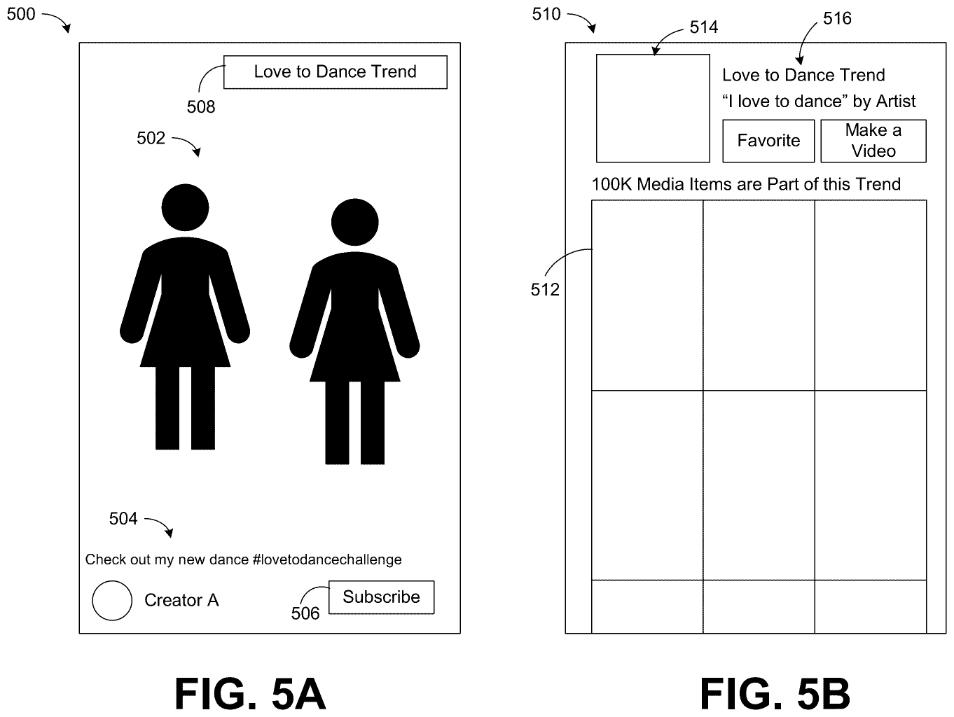

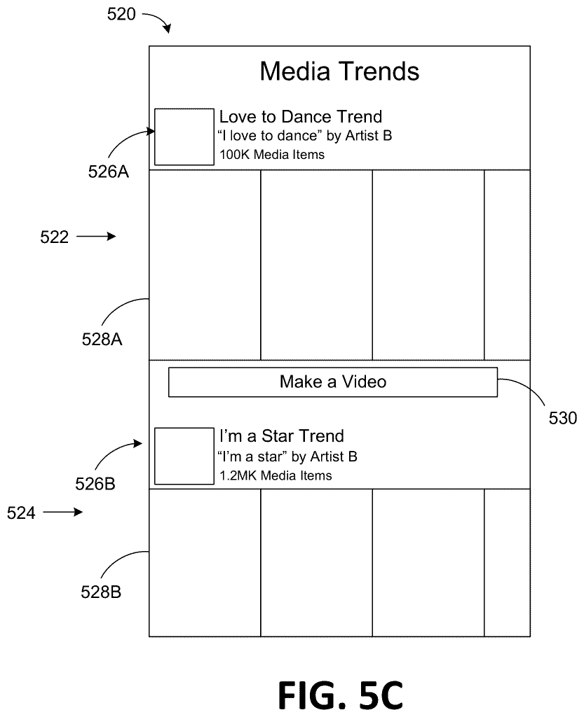

As indicated above, processing logic (e.g., viewer discovery component 316) can determine that one or more media items 121 of the set of media items is associated with a media trend of the platform. In such embodiments, the GUI provided to the client device 102 can include an indication that such media item 121 is associated with the media trend. FIG. 5A illustrates an example GUI 500, in accordance with implementations of the present disclosure. As illustrated by FIG. 5A, the GUI 500 can include content 502 of a media item 121 identified for sharing with the user of platform 120 (e.g., in accordance with the request received at block 402). In some embodiments, GUI 500 can include additional information 504 associated with the content 502. For example, GUI 500 can include a title associated with the content 502, a caption associated with the content 502, one or more keywords or hashtags associated with the content 502, an indication of a creator associated with the content 502, and so forth. In some embodiments, media item manager 132 and/or viewer discovery component 316 can obtain such information 504 for the media item 121 based on metadata for the media item 121 (e.g., stored at media item data store 252). In some embodiments, GUI 500 can include one or more GUI elements 506 that enable the user to engage with content 502 of the media item 121 and/or a creator of content 502. For example, GUI 500 can include a GUI element 506 that enables the user to “subscribe” to an account or page of the content's creator. Upon detecting that the user has engaged with such GUI element 506, media item manager 132 can identify additional media items 121 provided by the creator for sharing with the user (e.g., at the current time period, at a future time period, etc.).

As illustrated in FIG. 5A, GUI 500 can include a GUI element 508 that notifies the user that the media item 121 presented via GUI 500 is associated with a detected media trend of platform 120. In some embodiments, the GUI element 508 can include information pertaining to the media trend. For example, the GUI element 508 can indicate a name or title of the media trend, one or more characteristics of the media trend (e.g., a type of the trend, etc.), audio content associated with the media trend (e.g., a song associated with the media trend), a number of media items 121 of platform 120 associated with the media trend, and so forth. In some embodiments, the GUI element 508 can be an interactive GUI element (e.g., a button, etc.). As will be seen below, viewer discovery component 316 can provide a user with access to other media items of the media trend (e.g., upon detection of a user interaction with the GUI element 508).

Referring back to FIG. 4, at block 406, processing logic detects a user interaction, via the GUI, with a GUI element associated with at least one of the one or more media items associated with the media trend. In some embodiments, viewer discovery component 316 can detect a user interaction with GUI element 508, as described above. At block 408, processing logic provides, to the client device, an additional GUI including, for presentation to the user, audiovisual content of a set of media items associated with the media trend. In some embodiments, upon detecting a user interaction with GUI element 508, viewer discovery component 316 can provide client device 102 with an additional GUI, such as GUI 510 of FIG. 5B. As illustrated by FIG. 5B, GUI 510 can include content 512 for additional media items 121 associated with the media trend. GUI 510 can additionally or alternatively include information associated with the media trend. For example, GUI 510 can include a GUI element 514, which can include an image or other such data that indicates one or more visual features pertaining to the media trend. In an illustrative example, GUI element 514 can include image content and/or video content associated with a media item 121 that is determined to have inspired the media trend (e.g., as described above with respect to FIG. 3). In another illustrative example, the media trend may be associated with particular audio content (e.g., a particular song). GUI element 514 can include image content representing the particular audio content (e.g., an album cover for an album that includes the particular song, an image provided by a creator of the song, etc.). GUI 510 can also include additional GUI elements 516 pertaining to the media trend. For example, GUI 510 can include one or more GUI elements 516 that indicate a title of the media trend (e.g., “Love to Dance Trend”), audio content of the media trend (e.g., “‘I love to dance’ by Artist”), a number of media items 121 of platform 120 that are associated with the media trend (e.g., “100K media items”), and so forth.

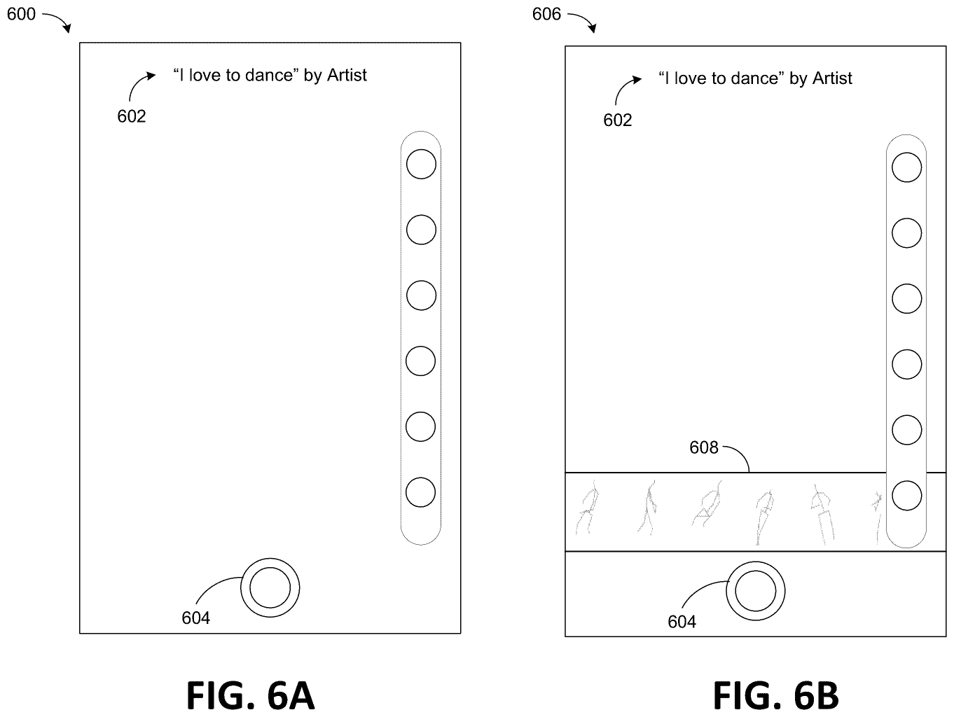

In some embodiments, GUI elements 516 can also include one or more interactive GUI elements (e.g., buttons, etc.). For example, GUI elements 516 can include a “favorite” button, which allows a user to designate the media trend and/or media items 121 of the media trend as a “favorite” of the user. Upon detection of a user interaction with the “favorite” button, media item manager 132 and/or viewer discovery component 316 can identify additional media items 121 associated with the media trend for sharing with the user (e.g., in response to a future request for media items 121 received from client device 102). In another example, GUI elements 516 can include a “make a video” button, which enables the user to create their own content corresponding to the concept or format of the media trend. Further details regarding such features are described with respect to FIGS. 6A-6B below.

As described above, the user of the platform 120 (e.g., that provided the request of block 402) can engage with media items 121 of a media trend via GUIs 500, 510. In some embodiments, such engagement can include indicating that media items 121 of the media trend are of interest to the user (e.g., based on a “like” or “subscribe” of the user to the media items 121 of the media trend). In other or similar embodiments, such engagement can include indicating that the media trend is “favorited” by the user (e.g., based on an engagement with a GUI element 516, described above). In some embodiments, processing logic can detect the user engagement with such media items 121 of the media trend and can determine, based on the user engagement, that one or more engagement criteria associated with the content of media items 121 of the media trend is satisfied. Processing logic can update metadata associated with the client device 102 of the user to indicate that the one or more engagement criteria are satisfied, in some embodiments. In such embodiments, media item manager 132 can receive an additional request from the client device 102 (e.g., at a later time period) for media items 121 of platform 120. Media item manager 132 can identify media items 121 associated with the media trend for sharing with the user in accordance with the additional request based on the updated metadata, as described herein.

FIG. 5C illustrates another example GUI 520 associated with visualizing media trends of platform 120. As illustrated by FIG. 5C, GUI 520 can include one or more sections (e.g., section 522, section 524, etc.) that includes information 526 associated with respective media trends detected at platform 120 and/or content 528 for media items associated with such media trends. In an illustrative example, section 522 of GUI 520 can include information 526A pertaining to a first media trend (e.g., the “Love to Dance Trend”), as described above, and content 528A of one or more media items 121 associated with the first media trend. Additionally or alternatively, section 524 of GUI 520 can include information 526B pertaining to a second media trend (e.g., the “I'm a Star Trend”), as described above, and content 528B of one or more media items 121 associated with the second media trend. In some embodiments, GUI 520 can additionally or alternatively include a GUI element 530, which enables a user to create content corresponding to the media trend, as described herein with respect to FIGS. 6A-6B. In some embodiments, viewer discovery component 316 can provide a user with access to GUI 520 upon detection of a user interaction with GUI element 508 of FIG. 5A, as described above. In other or similar embodiments, viewer discovery component 316 can provide the user with access to GUI 520 upon detection of a user interaction with another GUI element of a GUI of platform 120 and/or upon receiving the request for access to media items 121 (e.g., according to block 402 of method 400).

It should be noted that embodiments and examples provided with respect to FIGS. 5A-5C, as well as FIGS. 6A-6B, are provided for the purpose of example and illustration only. The designs of GUIs 500, 510, and/or 520 are merely provided as examples and are not intended to be limiting. GUIs 500, 510, and/or 520 can include additional or alternative GUI elements, in accordance with embodiments described herein. Further, media item manager 132 and/or viewer discovery component 316 can provide users with access to different GUIs which may or may not include GUI elements of GUIs 500, 510, and/or 520, in accordance with embodiments described herein.

FIGS. 6A-6B illustrate additional example GUIs 600, 606 for visualizing media trends at a content sharing platform, in accordance with implementations of the present disclosure. In some embodiments, GUIs 600, 606 may enable a user of platform 120 to create content for a media item based on a concept or format of a detected media trend, as described herein. In some embodiments, viewer discovery component 316 can provide a user with access to GUIs 600, 606 upon detecting a user interaction with a GUI element 516 (e.g., “make a video” button) of FIG. 5B and/or GUI element 520 of FIG. 5C. Viewer discovery component 316 and/or media item manager 132 can provide a user with access to GUIs 600, 606 upon detection of a user interaction with other GUI elements of one or more GUIs of platform 120.

As indicated above, GUI 600 can include one or more GUI elements that enable a user to create content for a media item 121 according to the concept or format of a media trend. In some embodiments, GUI 600 can include one or more GUI elements 602 that indicate audio content of a media trend for inclusion in the media item 121. In an illustrative example, the “Love to Dance” media trend described above can be associated with the song “I love to dance” by Artist. GUI element 602 of GUI 600 can indicate the song (or a portion of the song) for inclusion with the media item 121 based on the concept of the media trend. GUI 600 can additionally or alternatively include additional GUI elements 604 that enable the user to initiate a recording of visual content for the media item 121. Upon detection of a user interaction with GUI element 604, client device 102 can activate one or more audiovisual components (e.g., a camera component, etc.) and can initiate generation of audiovisual data (e.g., image data, etc.) for objects included in a vantage point of the audiovisual components. In some embodiments, client device 102 and/or viewer discovery component 316 can initiate playback of the song (or portion of the song) indicated by GUI element 602 via an audio component (e.g., a speaker) of client device 102 or another device connected to client device 102 (e.g., a speaker device connected to client device 102 via a wired or wireless connection). The user can use client device 102 to capture audiovisual content pertaining to the trend based on the recording initiated by the client device 102 and/or the playback of the song.

In accordance with embodiments described herein, trend engine 152 can determine one or more visual features that are common to content of media items 121 associated with a media trend. Such visual features can correspond to poses of objects depicted by such content, in some embodiments. Viewer discovery component 316 can provide a user with an indication of such visual features via GUI 606 (e.g., before or during recording of the content for the media item 121). For example, as described above, trend engine 152 may generate audiovisual embeddings for a media item 121 representing audiovisual features of the media item. Such media item can be identified as a template media item, as described herein, and/or can be identified as a media item 121 that inspired the creation of the media trend. In some embodiments, the audiovisual embeddings can include a pose embedding, which represents one or more poses of an object depicted by the media item 121 across a sequence of video frames of the media item 121. In some embodiments, trend engine 152 can extract one or more pose embeddings from a media item 121 determined to be associated with a media trend and can generate or otherwise obtain image data illustrating the poses indicated by the one or more pose embeddings. In some embodiments, each pose embedding can include a pose value corresponding to one or more poses of a set of predefined poses for the object depicted by the sequence of video frames. Trend engine 152 can generate or obtain the image data illustrating the poses by determining which predefined poses correspond to the pose values of the pose embeddings and including a visual representation of such predefined poses in the image data. In other or similar embodiments, trend engine 152 can provide the pose embeddings as an input to an AI model trained to generate image data representing visual features of given embeddings. Trend engine 152 can extract the image data from one or more outputs of the AI model.

In some embodiments, GUI 606 can include the image data 608 representing the poses of objects depicted by content of the media trend. Viewer discovery component 316 (or another component of platform 120) can provide the user with access to image data 608 prior to or upon detecting a user engagement with GUI element 604. As illustrated by FIG. 6B, image data 608 depicts poses that the user should adopt when creating the content in accordance with the media trend.

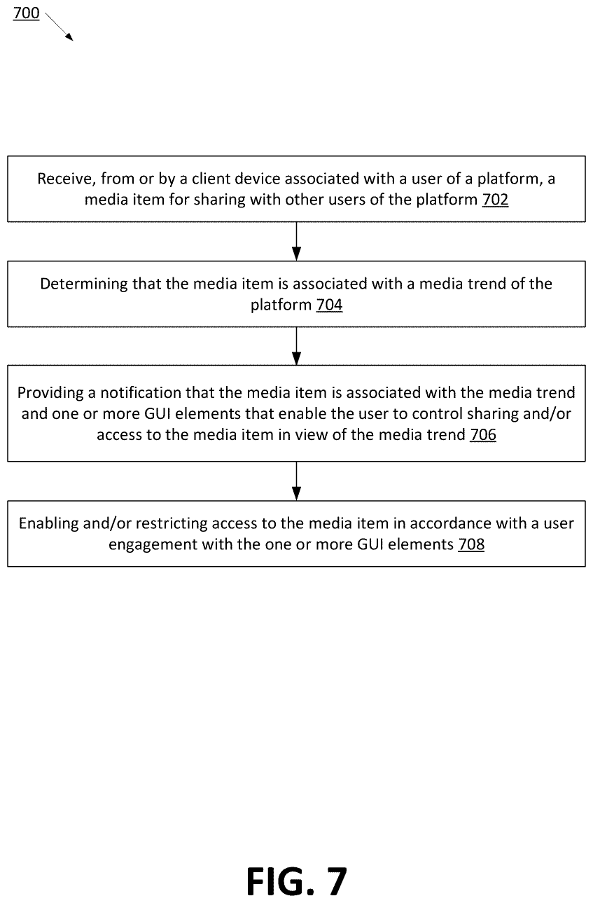

FIG. 7 is a block diagram of an example method for enabling creator-based control of media items of a media trend, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by trend engine 152. For example, some or all of operations of method 400 can be performed by one or more components of trend discovery module 216 (e.g., creator discovery component 318). In other or similar embodiments, some or all the operations of method 700 can be performed by a client device 102 of system 100. In yet other or similar embodiments, some or all of the operations of method 700 can be performed by media item manager 132 and/or trend engine 152, and one or more client devices 102 of system 100 (e.g., in parallel, concurrently, sequentially, etc.).

At block 702, processing logic receives, from a client device associated with a user of a platform, a media item for sharing with other users of the platform. In some embodiments, media item manager 132 can receive the media item 121 from a client device 102 associated with a creator of platform 120, as described herein. At block 704, processing logic determines that the media item is associated with a media trend of the platform. Trend engine 152 can determine that the media item 121 is associated with the media trend in accordance with embodiments described above.

At block 706, processing logic provides, to the client device, a notification that the media item is associated with the media trend and one or more GUI elements that enable the user to control sharing and/or access to the media item in view of the media trend. In some embodiments, upon determining that the media item 121 is associated with a media trend, creator discovery component 318 can provide a notification to a client device 102 of the creator indicating that the media item 121 is determined to be a part of a media trend 121. In some embodiments, the notification can notify the creator that the media item 121 is identified as a template media item and/or is identified to have inspired the media trend. Client device 102 of the creator can provide the creator with access to the notification via a GUI of platform 120, in some embodiments.

In additional or alternative embodiments, the GUI of platform 120 can include one or more GUI elements (not shown) that enable the creator to control sharing and/or access to the media item, in view of the media trend. In an illustrative example, the GUI elements can include a GUI element that enables the creator to request that the media item not be associated with the media trend. Upon detecting a user interaction with such GUI element, client device 102 can transmit a notification of the user interaction to platform 120. Media item manager 132 and/or trend engine 152 can update media item data store 252 to indicate that the media item 121 is not to be associated with the media trend. In another illustrative example, the GUI elements can include a GUI element that enables the creator to specify characteristics of users that are permitted to be notified of the association of the media item 121 with the media trend. Upon detecting a user interaction with such GUI element, client device 102 can transmit a notification of the user interaction to platform 120. Media item manger 132 and/or trend engine 152 can update media item data store 252 to indicate the characteristics of users specified by the creator. Media item manager 132 and/or trend engine 152 may provide users with access to such media item 121, as described above, but may only notify users that such media item 121 is associated with the media trend if such users have the characteristics specified by the creator.

In yet another illustrative example, the GUI elements can include a GUI element that enables the creator to limit the generation of new media items for the media trend based on the creator's media item 121. In some instances, users of platform 120 may be inspired to create their own content corresponding to the media trend after accessing a media item 121 provided by a creator. Such users may create content for the media trend (e.g., as described with respect to FIGS. 6A-6B) and may attribute the media item 121 including the created content with the media item 121 of the creator. When such media item 121 inspired by the creator's media item is accessed by other users of the platform 120, platform 120 (e.g., viewer discovery component 316) may provide a notification of the creator's media item as the inspiration for such media item 121. In some embodiments, a GUI element provided to the creator, as described above, allows the creator to limit the generation and/or sharing of new media items that are created based on content of the creator's media item. Upon detecting a user interaction with such GUI element, client device 102 can transmit a notification of the user interaction to platform 120. Media item manger 132 and/or trend engine 152 can update media item data store 252 to indicate whether users are permitted to generate new media items 121 based on the creator's media item 121 and/or whether the creator's media item 121 is to be associated with the new media items 121 (e.g., when the new media items 121 are accessed by other users of platform 120).

At block 708, processing logic enables and/or restricts access to the media item in accordance with a user engagement with the one or more GUI elements. Media item manager 132 and/or creator discovery component 318 can perform operations to enable and/or restrict access to the media item, as described above.

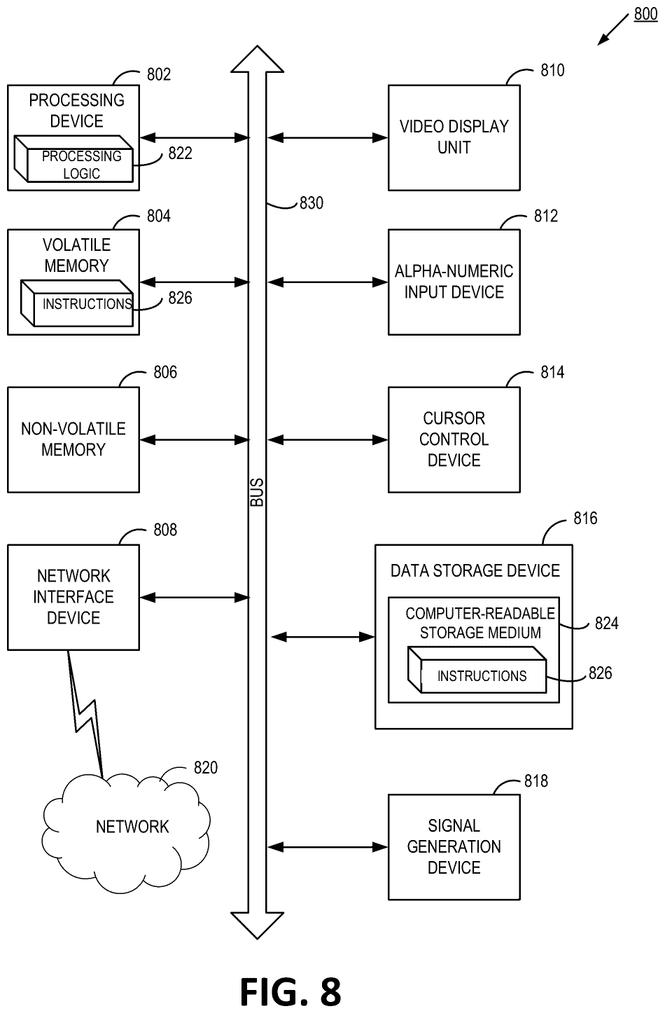

FIG. 8 is a block diagram illustrating an exemplary computer system 800, in accordance with implementations of the present disclosure. The computer system 800 can correspond to platform 120, client devices 102A-N, server machine 130, server machine 150, and/or predictive system 180 described herein and with respect to FIGS. 1-7. Computer system 800 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 818, which communicate with each other via a bus 840.

Processor (processing device) 802 represents one or more general-purpose processing devices such as a microprocessor, central processing unit, or the like. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application specific integrated circuit (ASIC), a field programmable gate array (FPGA), a digital signal processor (DSP), network processor, or the like. The processor 802 is configured to execute instructions 805 for performing the operations discussed herein.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 820 (e.g., a speaker).

The data storage device 818 can include a non-transitory machine-readable storage medium 824 (also computer-readable storage medium) on which is stored one or more sets of instructions 805 embodying any one or more of the methodologies or functions described herein. The instructions can also reside, completely or at least partially, within the main memory 804 and/or within the processor 802 during execution thereof by the computer system 800, the main memory 804 and the processor 802 also constituting machine-readable storage media. The instructions can further be transmitted or received over a network 830 via the network interface device 808.

In one implementation, the instructions 805 include instructions for providing fine-grained version histories of electronic documents at a platform. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving a request of a client device for media items of a platform;
providing, for presentation on the client device, a graphical user interface (GUI) comprising audiovisual content of one or more media items and an indication that at least one of the one or more media items is associated with a media trend of the platform, wherein the media trend is associated with a plurality of media items comprising the one or more media items, and wherein content of each of the plurality of media items share common audiovisual characteristics in accordance with a concept of the media trend;
detecting a user interaction, via the GUI, with a GUI element associated with the at least one of the one or more media items associated with the media trend; and
responsive to the detection, providing, for presentation on the client device, an additional GUI comprising audiovisual content of the plurality of media items associated with the media trend.

2. The method of claim 1, further comprising:
determining that one or more engagement criteria associated with the audiovisual content of a set of media items associated with the media trend included via at least one of the GUI or the additional GUI are satisfied; and
updating metadata associated with the client device to indicate that the one or more engagement criteria are satisfied.

3. The method of claim 2, further comprising:
receiving an additional request of the client device for additional media items of the platform;
identifying, based on the updated metadata associated with the client device, a set of additional media items for presentation via the GUI of the client device in response to the request, wherein at least one of the set of additional media items is associated with the media trend; and
updating the GUI of the client device to include audiovisual content of the set of additional media items.

4. The method of claim 2, wherein determining that the one or more engagement criteria associated with the audiovisual content of the set of media items associated with the media trend is satisfied comprises:
detecting an additional interaction via at least one of the GUI or the additional GUI with one or more additional GUI elements associated with designating media items associated with the media trend as media items of interest to the user.

5. The method of claim 1, wherein the additional GUI further comprises audiovisual content of one or more additional pluralities of media items, wherein each of the one or more additional pluralities of media items is associated with a distinct media trend of the platform.

6. The method of claim 1, wherein the additional GUI further comprises an additional GUI element that, when selected by the user, enables the user to request generation of content having at least one common audiovisual feature of the plurality of media items associated with the media trend.

7. The method of claim 6, further comprising:
responsive to detecting a user interaction with the additional GUI element, activating an audiovisual component of the client device;
obtaining audiovisual data generated by the activated audiovisual component; and
generating an additional media item based on the obtained audiovisual data and the at least one common audiovisual feature of the plurality of media items.

8. The method of claim 7, further comprising:
providing, for presentation on the client device, another additional GUI comprising one or more GUI elements corresponding to instructions for the user to replicate actions to reflect audiovisual features corresponding to the media trend.

9. The method of claim 1, wherein the additional GUI further comprises an indication of a number of the plurality of media items associated with the media trend.

10. The method of claim 1, wherein the additional GUI further comprises an indication of a media item of the plurality of media items associated with the media trend for which the media trend originated.

11. A system comprising:
a memory; and
a set of one or more processing devices connected to the memory, wherein the set of one or more processing devices is to perform operations comprising:
receiving a request of a client device for media items of a platform;
providing, for presentation on the client device, a graphical user interface (GUI) comprising audiovisual content of one or more media items and an indication that at least one of the one or more media items is associated with a media trend of the platform, wherein the media trend is associated with a plurality of media items comprising the one or more media items, and wherein content of each of the plurality of media items share common audiovisual characteristics in accordance with a concept of the media trend;
detecting a user interaction, via the GUI, with a GUI element associated with the at least one of the one or more media items associated with the media trend; and
responsive to the detection, providing, for presentation on the client device, an additional GUI comprising audiovisual content of the plurality of media items associated with the media trend.

12. The system of claim 11, wherein the operations further comprise:
determining that one or more engagement criteria associated with the audiovisual content of a set of media items associated with the media trend included via at least one of the GUI or the additional GUI are satisfied; and
updating metadata associated with the client device to indicate that the one or more engagement criteria are satisfied.

13. The system of claim 12, wherein the operations further comprise:
receiving an additional request of the client device for additional media items of the platform;
identifying, based on the updated metadata associated with the client device, a set of additional media items for presentation via the GUI of the client device in response to the request, wherein at least one of the set of additional media items is associated with the media trend; and
updating the GUI of the client device to include audiovisual content of the set of additional media items.

14. The system of claim 13, wherein determining that the one or more engagement criteria associated with the audiovisual content of the set of media items associated with the media trend is satisfied comprises:
detecting an additional interaction via at least one of the GUI or the additional GUI with one or more additional GUI elements associated with designating media items associated with the media trend as media items of interest to the user.

15. The system of claim 11, wherein the additional GUI further comprises audiovisual content of one or more additional pluralities of media items, wherein each of the one or more additional pluralities of media items is associated with a distinct media trend of the platform.

16. The system of claim 11, wherein the additional GUI further comprises an additional GUI element that, when selected by the user, enables the user to request generation of content having at least one common audiovisual feature of the plurality of media items associated with the media trend.

17. The system of claim 16, wherein the operations further comprise:
responsive to detecting a user interaction with the additional GUI element, activating an audiovisual component of the client device;
obtaining audiovisual data generated by the activated audiovisual component; and
generating an additional media item based on the obtained audiovisual data and the at least one common audiovisual feature of the plurality of media items.

18. A non-transitory machine-readable storage medium comprising instructions that, when executed by a processing device, cause the processing device to perform operations comprising:
receiving a request of a client device for media items of a platform;
providing, for presentation on the client device, a graphical user interface (GUI) comprising audiovisual content of one or more media items and an indication that at least one of the one or more media items is associated with a media trend of the platform, wherein the media trend is associated with a plurality of media items comprising the one or more media items, and wherein content of each of the plurality of media items share common audiovisual characteristics in accordance with a concept of the media trend;
detecting a user interaction, via the GUI, with a GUI element associated with the at least one of the one or more media items associated with the media trend; and
responsive to the detection, providing, for presentation on the client device, an additional GUI comprising audiovisual content of the plurality of media items associated with the media trend.

19. The non-transitory machine-readable storage medium of claim 18, wherein the operations further comprise:
determining that one or more engagement criteria associated with the audiovisual content of a set of media items associated with the media trend included via at least one of the GUI or the additional GUI are satisfied; and
updating metadata associated with the client device to indicate that the one or more engagement criteria are satisfied.

20. The non-transitory machine-readable storage medium of claim 19, wherein the operations further comprise:
receiving an additional request of the client device for additional media items of the platform;
identifying, based on the updated metadata associated with the client device, a set of additional media items for presentation via the GUI of the client device in response to the request, wherein at least one of the set of additional media items is associated with the media trend; and
updating the GUI of the client device to include audiovisual content of the set of additional media items.
